(19) United States
(12) Patent Application Publication
(10) Pub. No.: US 2010/0253454 A1
(43) Pub. Date: Oct. 7, 2010

(54) BALUN FOR MAGNETIC RESONANCE IMAGING

(75) Inventors: Harry Schilling, Eichstatt (DE); Wolfgang Loew, Munchen (DE); Iris Metzner, Neubiberg (DE)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/752,679

(22) Filed: Apr. 1, 2010

Related U.S. Application Data
(63) Continuation of application No. 12/542,491, filed on Aug. 17, 2009, now abandoned.

(30) Foreign Application Priority Data
Aug. 22, 2008 (DE) 102008041465.4

(51) Int. Cl. H01F 21/00

(52) U.S. Cl. 336/20

(57) ABSTRACT

An inductive component in the form of a balun for use in magnetic resonance imaging tomographs comprises a winding of a coaxial line. For adjusting inductance of the winding, a length of the winding of the coaxial line is deformable. For this, a first end of the coaxial line is fastened to a first fastening block, and a second end to a second fastening block. Change of the length is effected by means of an adjusting screw which varies the distance between the two fastening blocks.

### CROSS-REFERENCE TO RELATED APPLICATIONS

This application claims priority from pending German Patent Application No. 10 2008 041 465.4 filed on Aug. 22, 2008 and is a Continuation of U.S. patent application Ser. No. 12/542,491 filed Aug. 17, 2009.

### BACKGROUND OF INVENTION

1. Field of the Invention

The invention relates to a coil arrangement or inductive component in the form of a balun for magnetic resonance imaging tomography, and in particular to medical instruments for examination of human and animal bodies.

2. Description of the Relevant Art

Magnetic resonance imaging tomography is an imaging method which is based on the physical phenomenon of magnetic spin resonance. Magnetic resonance imaging is also designated as magnetic resonance tomography, shortened to MRT. An object to be examined is subjected to a strong magnetic field. Owing to this, the spins of nuclei of individual atoms, which previously were statistically distributed, are aligned. Owing to an outer excitation with high-frequency energy, a measurable oscillation is excited. Now in order to make possible a spatial localization, magnetic fields are generated along three spatial axes in the magnetic field by means of gradient coils. Transmission coils are provided for emitting the high-frequency excitation energy. Reception of the excited oscillations is effected by receiving coils. Frequently transmission coils and receiving coils are combined with each other. In the following these various types of coils are also designated as HF coils, because they serve for coupling-in or coupling-out high-frequency signals.

With the non-invasive MRT imaging method, sectional images along desired axes through a human or animal body can be recorded.

Various circuits are known for coupling-on the HF coils to an evaluating circuit of a magnetic resonance imaging tomograph. Owing to their function, these are frequently also designated as baluns. The purpose of these circuits usually consists of adapting a symmetrical HF coil to an unsymmetrical line, and simultaneously of suppressing sheath currents at the resonance frequency of the device. A circuit of this kind is disclosed, for example, in U.S. Pat. No. 5,371,466. The basic circuit is illustrated in FIG. 2A of U.S. Pat. No. 5,371,466. A coil 60 built up of a coaxial cable serves to adapt the symmetrical coil 24 to an unsymmetrical HF receiver. Furthermore, a capacitor 62 is connected in parallel with the coil to form with the coil itself a resonance circuit which is tuned to the resonance frequency of the HF coil 24. This achieves that a signal received by the coil 24 can be transmitted exclusively as a difference signal via the coaxial cable. A sheath current that propagates preferably along the screen of the coaxial cable to a receiver is suppressed by the resonance circuit consisting of the coil 68 and the capacitor 62. The technical design of a device of this kind is illustrated for example in FIG. 5A of U.S. Pat. No. 5,371,466. A coil 102 built-up of a coaxial cable is connected between the input and output terminals of the arrangement. Located on the underside of the arrangement, as illustrated in FIG. 5B of U.S. Pat. No. 5,371,466, and parallel to the coil is a fixed capacitor 106 together with a parallel trimming capacitor 104 for fine adjustment of the resonance frequency of the resonance circuit. A disadvantage of this arrangement is the large requirement of space, and also the difficulty of performing adjustment which is effected first in rough steps by inserting a suitable capacitor 106, and then by fine adjustment by rotating a control knob on a trimming capacitor 104. Furthermore it is known that trimming capacitors of this kind become de-adjusted during the course of time. Accordingly, a rotation of the capacitor from its set position must be prevented, for example with screw-locking lacquer.

### SUMMARY OF THE INVENTION

The embodiments described herein address some of the disadvantages of prior art systems by introducing a circuit arrangement which permits a simplification of mechanical construction, a reduction of size and manufacturing costs, and also a simplification of adjustment, whilst retaining or improving the electrical properties. Additionally, a coil arrangement has been developed that can be manufactured to be of smaller size and at more favorable cost, thus permitting easier adjustment.

In accordance with an embodiment, these objects may be achieved with an inductive component in the form of a balun for use in magnetic resonance imaging tomographs, including:

a winding formed by a coaxial line to have an inductance;

a holder for accommodating the winding; and

at least one means for changing a geometry of the inductive component for adjusting the inductance of the inductive component.

### BRIEF DESCRIPTION OF THE DRAWINGS

In the following the invention will be described by way of example, without limitation of the general inventive concept, on examples of embodiment and with reference to the drawings.

FIG. 1 shows an embodiment of an inductive component.

FIG. 2 shows a circuit diagram of a case of application of an inductive coil arrangement.

FIG. 3 shows a circuit diagram of another case of application of an inductive coil arrangement.

FIG. 4 shows an inductive component in a screen can.

FIG. 5 shows an inductive component having a reduced angle of tilt of the winding.

FIG. 6 schematically shows an inductive component.

FIG. 7 shows a screened inductive component.

FIG. 8 schematically shows a magnetic resonance imaging tomograph.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION

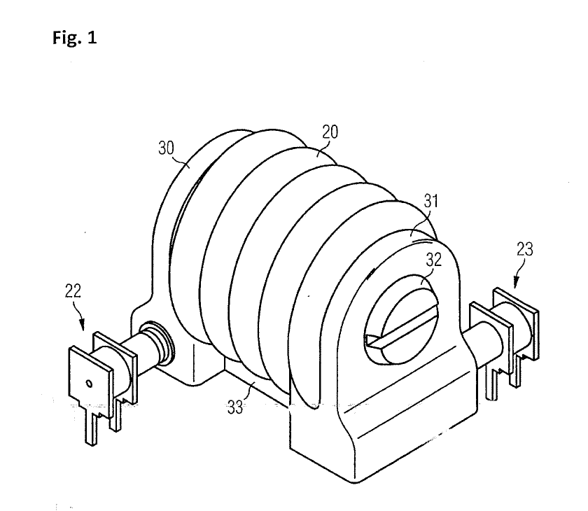

FIG. 1 shows an embodiment of an inductive component according to an embodiment. The inductance itself is formed by a winding of a coaxial line 20 which in the present example is a semi-rigid line. As the winding includes a coaxial line with an inner conductor and an outer conductor a balun results, input terminals 22 of which are disposed on a first side of the line, and output terminals 23 of which are disposed on a second side of the line. The terminals 22 and 23 each include two individual terminals, with a first terminal contacting the outer conductor and a second terminal contacting the inner conductor of the coaxial line. A first fastening block 30 and also a second fastening block 31 are provided for mechanically accommodating the coaxial line 20. The first fastening block 30 fixes the winding of the coaxial line on an input side of the balun, whilst the second fastening block 31 fixes the winding on an output side. In the simplest case, the intermediately located windings of the coaxial line 20 are held exclusively by the rigidity of the line. In another favorable embodiment, a core is also provided, preferably of a synthetic material, for radially fixing the winding. Alternatively, the winding also may be embedded in an elastic material, such as silicone rubber for example. The synthetic material optionally may include a solid synthetic material along which the turns of the winding may slide, or also of an elastic material which is deformed together with the winding. For fine adjustment of the inductance an adjusting screw 32 is provided which slightly changes the distance between the first fastening block 30 and the second fastening block 31. With a typical coil length of 10 mm, in a practical case a change of length of less than 1 mm is sufficient for adjustment. In order to simplify the assembly and to increase the stability of the arrangement, a connecting piece 33 also is provided between the first fastening block 30 and the second fastening block 31. This ensures that during fine adjustment of the coil no forces act on the electrical terminals at the input 22 and the output 23 of the balun. Thus, the lower region of the arrangement is rendered more rigid by the connecting bridge. When the adjusting screw 32 is turned, only the upper regions of the first and second fastening block around the screw are slightly moved away from each other, and thus slightly tilted. The terminals of the coil may be designed optionally to have pins for bores in printed circuit boards, or as SMD terminals for surface mounting.

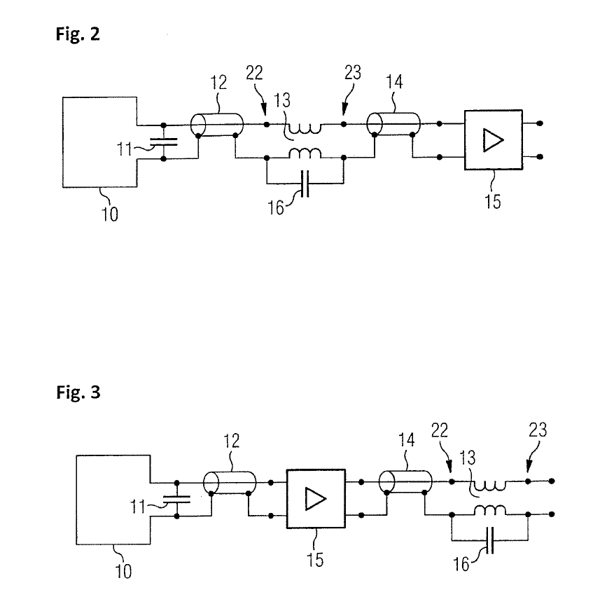

FIG. 2 shows a circuit diagram of a case of application of an inductive coil arrangement. A coil 10 (field coil) is shown here only in simplified manner. Typically a row of series capacitors are incorporated along the extent of the coil. This coil is supplemented with a capacitor 11 to form a resonance circuit. A signal from the coil is now conducted away by means of a first line 12. This first line 12 is here shown as a coaxial line, but it can be also any other kind of line, for example a symmetrical line. Now a balun 13 with terminals 22 and 23 is located at the end of this line 12 as a separate component as shown for example in FIG. 1. A parallel capacitor 16 is connected into the circuit in parallel with this balun. This is typically a narrow-tolerance SMD component which is soldered onto the same printed circuit board as the balun and in parallel therewith. Another line 14, preferably now a coaxial line, is provided at the output terminals 23 of the balun to relay the signals to an amplifier 15. This amplifier amplifies the signals from the coil 10 and passes them on to an evaluation circuit of the magnetic resonance imaging tomograph.

FIG. 3 shows another variant of the circuit of FIG. 2. In this the positions of the amplifier 15 and the balun 13 together with the capacitor 16 are interchanged. Thus, the signal supplied from the coil 10 via the line 12 is first amplified by means of the amplifier 15, and then relayed via the evaluation circuit of the magnetic resonance imaging tomograph via the balun 13 with the parallel capacitor 16. Basically it is possible to dispose a plurality of baluns 13 with or without a parallel capacitor 16 along the line train between the coil 10 and the evaluation electronics of the magnetic resonance imaging tomograph. This is especially necessary when the length of the line is large. Further-more, by interposing a plurality of baluns in the circuit, the suppression of high-frequency sheath currents in the outer conductor of the coaxial line can be further improved.

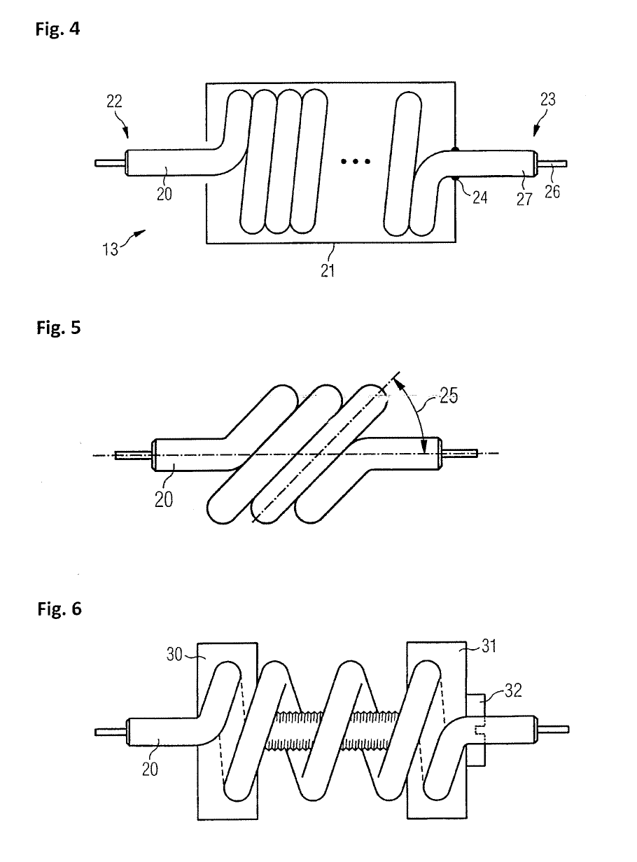

FIG. 4 shows a component in a screening housing. In order to keep stray fields of the coil of the balun as small as possible, the latter preferably can be incorporated in a screening housing 21. Here the line 20 is connected to the screening housing 21 only at positions of contact 24. This is preferably the case on the output side of the balun. On the other side, the line 20 of the balun is separated from the screening housing.

FIG. 5 illustrates the coil of an inductive component having a reduced angle of tilt of the winding. In this, the tilt angle 25 is the angle at which a center axis of the coaxial line 20 forming a turn of the winding is perceived to cross the center axis of the wound coil in its unstretched or unexpanded condition, as seen in a side view. This tilt angle is reduced in comparison with a normally wound coil. This results particularly in a more flat constructional shape of the coil.

FIG. 6 schematically shows an inductive component. Here the fastening blocks 30 and 31 and also the winding of a coaxial line 20 fixed in the region of the fastening blocks can be discerned particularly distinctly. The distance between the fastening blocks 30 and 31 can now be varied with the adjusting screw 32 to adjust the inductance.

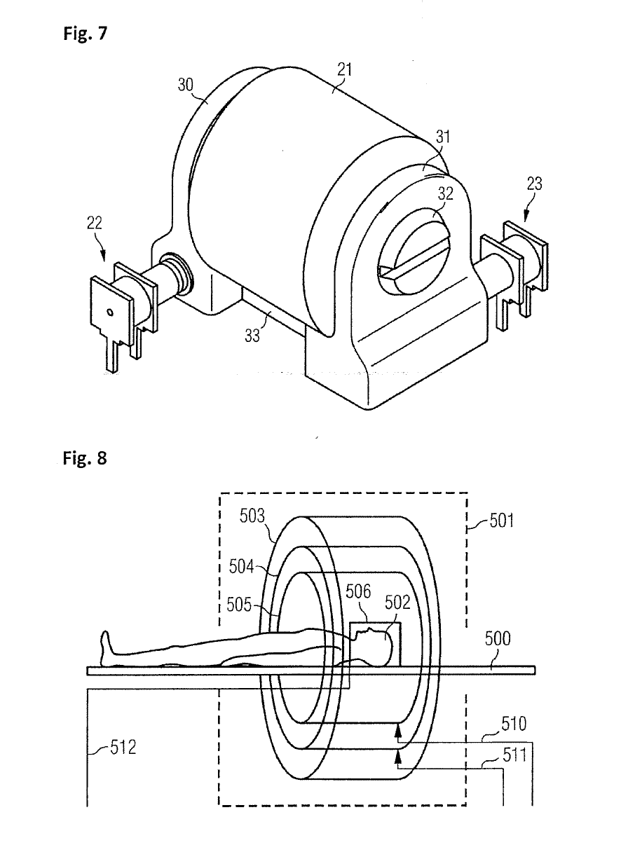

FIG. 7 shows an inductive component with screening. In this embodiment, a screening casing is provided around the winding. This screening casing can also extend further along the axial direction of the arrangement than is illustrated in the present case. Advantageously the screening casing is connected to a circuit ground, and more advantageously to a grounding surface.

FIG. 8 schematically shows in a general form a device for magnetic resonance imaging. A patient 502 rests on a berth 500 in a magnet system 501. Instead of a patient, also animals or any objects can be examined. A main magnet 503 serves to generate a static main magnetic field. For determination of location, temporally and spatially variable magnetic fields are generated by means of gradient coils 504. These are controlled by gradient signals 511. A high-frequency field for exiting magnetic resonances is introduced into an object to be examined with the aid of a transmitted signal 510 through transmission coils 505. Detection of a measurement signal 512 is effected by means of receiving coils 506. Optionally the transmission coils and the receiving coils can be combined spatially with each other. Similarly, the same coil arrangement can be used first for signal transmission, and later for signal reception. The receiving coils 506 also can be disposed in an outer region of the transmission coils 505. In similar manner, the transmission coils 505 can be disposed also in the vicinity of the object to be examined, similarly to the here illustrated receiving coils 506.

The invention comprises a coil 10 of variable length, and thus of variable inductance. A change of inductance is effected by shortening or stretching the coil by means of a mechanical adjusting element, for example an adjusting screw 34. By adapting the geometry of the coil in this way and correspondingly changing the inductance, a simple adjustment of the resonance frequency of the resonance circuit consisting of the coil 13 and the capacitor 16 connected in parallel with this is possible. In order to achieve as large as possible a suppression of sheath currents, it is of importance that the parallel resonance circuit including the coil 13 and the parallel capacitor 16 be of high quality. However, this also makes necessary a particularly exact adjustment of the resonance frequency. The coils known from prior art already exhibit considerable variations of inductance owing to mechanical tolerances of fabrication. A substantial improvement can be achieved here by the coil being built into a suitable holder. Thus, its geometry cannot be changed inadvertently during assembly. Because here the inductance is already exactly fixed, a determination of suitably matching capacities during adjustment of the resonance frequency can be frequently dispensed with. Thus, usually capacities having narrow tolerances and previously calculated values can be connected in parallel with the coil. Now in order to dispense with a trimming capacitor, i.e. an adjustable capacitor during fine adjustment, the inductance of the coil is adjusted. As the coil is used in an inner magnetic field of magnetic resonance imaging tomographs, it must not contain any ferromagnetic materials. An adjustment by altering a core introduced into the coil is thus not possible. In one embodiment, the adjustment is effected by deforming the coil. For this, in particular, its length is changed. In a typical case of application, complete adjustment can be effected by using capacitors 16 of narrow tolerance, which typically still have a tolerance of 1%, and by altering the inductance by a similar order of magnitude, namely about 1%. For this, as a first approximation, a change of length of an order of magnitude of only 1% is necessary. A change of length of this kind can be achieved with components that are firmly mounted on printed circuits.

In an especially advantageous embodiment of the invention, a holder is provided for the coil, which holder has a first fastening block 30 and also a second fastening block 31. The first fastening block fixes a part of the coil, by holding preferably a first turn, whilst the second fastening block fixes another part of the coil, by holding preferably a further turn, so that at least one non-fixed turn is located between the first fastening block and the second fastening block. Preferably a plurality of non-fixed turns are located between the two fastening blocks. Adjustment of the inductance is effected by changing the distance between the fastening blocks. If the fastening blocks 30 and 31 are moved close to each other, then the coil is shortened, whilst an increase of the distance between the fastening blocks stretches the coil. Accordingly, the spacing between the turns, or the entire length of the coil, changes. When the coil is shortened, its inductance increases, whilst it is reduced during stretching. As the adjusting element, preferably a screw is provided with which the distance between the first and the second fastening block can be adjusted. For use in magnetic resonance imaging tomographs this screw must be of a non-ferromagnetic material. Here, in particular, a screw of a synthetic material, and more preferably a screw comprising a glass-fiber-reinforced synthetic material can be chosen in order to achieve a high stability and long-time constancy of a set value.

In order to achieve a long-time stability of the arrangement, the coaxial line 20 is preferably designed to be a semi-rigid line. Of course, a conventional coaxial cable also can be used.

In another embodiment, the individual turns of the coaxial line 20 are designed to have a reduced tilt angle 25. Typically, an angle at which a turn of a coil is inclined to the center axis of the coil, here designated as angle of tilt, is determined by the thickness of the coaxial line from which the coil has been formed, provided that there is no space between adjacent turns. According to an embodiment, the angle of tilt of the turns with respect to the center axis of the coil can be reduced further, so that an oblique winding results. Furthermore, according to an embodiment an adjustability of the angle of tilt can be utilized for fine adjustment of the inductance. For this, the length of the coil can remain unchanged. In another embodiment, holder elements are mounted laterally of the coil, which holder elements are urged against each other for adjustment of the inductance, so that the tilt angle of the individual turns changes.

In another embodiment the winding is embedded in an at least slightly elastic mass, such as silicon rubber for example. Furthermore, a means is provided, for example a screw, for shortening or stretching the mass. It is of special advantage when a threaded element for engagement with the screw is provided in at least at one place of the mass. Furthermore, it is of advantage when another additional rigid element is provided, against which the head of the screw abuts. However, this can be also a turn of the coaxial line 20.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. Inductive component in the form of a balun for use in magnetic resonance imaging tomographs, comprising:
a winding formed by a coaxial line to have an inductance;
a holder for accommodating the winding; and
at least one means for changing a geometry of the inductive component for adjusting the inductance of the inductive component.

2. Inductive component according to claim 1, wherein the at least one means for changing the geometry is adapted to shorten or stretch a length of the winding.

3. Inductive component according to claim 1, wherein the means for changing the geometry is an adjusting screw.

4. Inductive component according to claim 1, wherein the holder comprises an elastic or plastic material.

5. Inductive component according to claim 1, wherein the holder comprises:
a first fastening block for holding a first turn of the winding, and a second fastening block for holding a further turn of the winding; and
an adjusting screw for changing a distance between the fastening blocks is provided for engagement with the fastening blocks.

6. Inductive component according to claim 1, wherein a connecting bridge is provided between the fastening blocks.

7. Inductive component according to claim 1, wherein a screening housing surrounds the winding.

8. Inductive component according to claim 1, wherein turns of the winding have a reduced angle of tilt from the center axis.
